(19) United States
(12) Patent Application Publication
(10) Pub. No.: US 2014/0297316 A1
(43) Pub. Date: Oct. 2, 2014

(54) Method And Apparatus For Adaptive Prefetching Of Medical Data

(71) Applicant: MCKESSON FINANCIAL HOLDINGS, Hamilton (BM)

(72) Inventor: Allan Noordvyk, Surry (CA)

(73) Assignee: McKesson Financial Holdings, Hamilton (BM)

(21) Appl. No.: 13/851,519

(22) Filed: Mar. 27, 2013

(51) Int. Cl. G06F 19/00

(52) U.S. Cl. CPC G06F 19/322
USPC 705/3

(57) ABSTRACT

A method, apparatus, and computer program product are described herein for providing clinically adaptive prefetch of datasets relating to prior medical studies. Upon indication of a new study, a fit function may depend on an exemplar set of new study to prior study relationships. The fit function may calculate an affinity value for a prior study, indicating the probability of relevancy to the new study. The fit function may consider structured data, and unstructured data, such as by natural language processing. Based on the affinity value, a dataset relating to the prior study may be flagged for prefetch, indicating a dataset should be prefetched from a lower tier memory to a higher tier memory, allowing for faster access to the dataset, from a clinical system. The fit function may be trained based on usage of the prior study datasets, including accounting for false positives and false negatives.

### TECHNOLOGICAL FIELD

Various embodiments of the invention are related to prefetching data from a medical imaging archiving system.

### BACKGROUND

In a medical imaging archiving system such as PACS (Picture Archiving and Communication System) or VNA (Vendor Neutral Archive) the large scale data (e.g., images and related information) representing a patient's past medical imaging studies are typically stored in a hierarchical storage management system (HSM) whereby a significant portion of the data is be located on the least expensive media (the lowest tier in the hierarchy). This lowest tier media is also the slowest, having retrieval times that are unacceptable for real time clinical use. In some cases this lowest tier may represent storage at an outside entity (mass storage service provider or another institution responsible for the master copy of the data) that is separated from the locality of data use by a slow wide-area-network (WAN).

Thus, medical imaging archiving systems typically use a process of prefetching, whereby the system attempts to determine which subset of the prior studies' data will be relevant for clinical comparison with a study that is expected to be performed in the near future. The system then attempts to move the data representing this relevant prior study subset to a higher tier of hierarchical storage ahead of need. This results in the needed data being primed in the HSM in a manner that supports high-speed interactive access upon request.

Current implementations of prefetching on medical imaging archiving systems require human interaction to initiate hard-coded prefetch rules, and manual updates to the prefetch rules as systems and/or clinical practice methodologies evolve over time. Prefetch rules are crude due to their dependency on structured data, and consideration to only a small portion of the characteristic information of each study (e.g. the body region being scanned and the modality of the device used in the scan). Further, these rules must be labouriously manually configured and results monitored based on the idiosyncratic needs of each institution and, in fact, individual specialists (who have different comparison needs for outwardly similar imaging procedures). Often an organization will leave the prefetching in a state that is suboptimal for their organization needs, but is at the limits of what can be reasonably be manually configured by human administrator on the limited set of parameters available to describe the content of the studies. Further, a human administrator may be unaware of the impact of changes in the institutional environment that necessitate a re-examination of the prefetch rules (e.g. reconfiguration of the tiers of the HSM, evolution in the standard of care for comparison imagery, increase in data sizes, etc.) and thus even an acceptably configured prefetch system may suddenly slide into inefficiency.

Additionally, if prefetch rules are overly aggressive and retrieve a large amount of data that is not clinically relevant, the HSM may become overtaxed due to unnecessary data churn between tiers, which could cause degradation in performance. However, if the prefetch rules are overly conservative, the prefetching will miss promoting data that is clinically relevant, causing physicians and other health care staff to be delayed in providing care to a patient while the needed data is pulled from the lowest tiers of deep storage.

### BRIEF SUMMARY

Embodiments of the present invention, among other things, address the above-referenced problem by providing clinically adaptive prefetching. As such, an affinity fit function may be trained by a clinic's use and/or non-use of data (e.g, medical images, and/or related textual information) during a study (e.g., a patient visit or evaluation). A trained affinity fit function may result in more efficient prefetching from the HSM, and may therefore enable more efficient access to clinically relevant data by a user of a clinical system.

A method, apparatus, and computer program product are therefore provided for providing clinically adaptive prefetching. A method is provided, including receiving an indication of a request for a new study for a patient, generating, with a processor, a partial clinical information lattice (PCIL) representative of the new medical study, receiving metadata describing a dataset related to a prior study for the patient, generating a complete clinical information lattice (CIL) representative of the dataset, calculating an affinity value for the prior study based on a fit function comparing the PCIL and the CIL, the affinity value indicating a probability of relevancy of the prior study to the new study, and identifying whether or not the dataset should be prefetched from lower tier memory.

In some embodiments, the PCIL comprises at least one of patient history, scan request, medical alert, pregnancy status, patient class, procedure type, body region, device modality, technologist notes, nursing notes, current patient location or requesting service. The CIL may extends the data elements of a PCIL to include at least one of a diagnostic report, location of study, make of a modality device, model of modality device, lab results and quantitative measurements. In some embodiments, at least one of the PCIL or CIL comprises at least unstructured text, and the fit function utilizes natural language processing to normalize terminology and analyze semantic relationships. In some embodiments, identifying whether or not the dataset should be prefetched from lower tier memory is based on a comparison of the affinity value to a threshold affinity value.

In some embodiments, the method includes analyzing a quantity of datasets identified for prefetch and a memory allocation, and adjusting the threshold affinity value based on the analysis. The method may further include utilizing actual aggregate end user behavior to identify a false negative dataset, wherein the false negative dataset is a dataset not identified for prefetch, but is requested for retrieval, and training the fit function based on the false negative and an associated CIL. In some embodiments, the method includes utilizing actual aggregate end user behavior to identify a false positive dataset, wherein the false positive dataset is a dataset erroneously identified for prefetch that is not utilized in the new study, and training the fit function based on the false positive dataset and an associated CIL. In some embodiments, the method includes generating a notification indicating optimization of the fit function is limited by a capacity of a high level storage medium. The method may include initializing the fit function based on an exemplar set of commonly accepted new study to relevant prior study relationships.

An apparatus is also provided, including at least one processor and at least one memory including computer program code, the at least one memory and the computer program code configured to, with the processor, cause the device to at least receive an indication of a request for a new study for a patient, generate a partial clinical information lattice (PCIL) representative of the new medical study, receive metadata describing a dataset related to a prior study for the patient, generate a complete clinical information lattice (CIL) representative of the dataset, calculate an affinity value for the prior study based on a fit function comparing the PCIL and the CIL, the affinity value indicating a probability of relevancy of the prior study to the new study, and identify whether or not the dataset should be prefetched from lower tier memory.

A computer program product is provided, including at least one non-transitory computer-readable storage medium having computer-executable program code instructions stored therein, the computer-executable program code instructions comprising program code instructions to authenticate a user affiliated with a clinic, receive clinical content associated with the clinic, provided by the user, store the clinical content in association with the clinic such that the clinical content is retrievable based on an indication of the clinic, receive an indication of a request to view content associated with the clinic, and cause display of the clinical content in response to the indication of the request.

A system is also provided, including a first and second device. The first device may be configure to provide an indication of a request for a new study for a patient, transmit the indication to a second device, and receive, from the second device, an indication of at least one dataset to be prefetched from lower tier memory. The second device may be configured to receive, from the first device, the indication of a request for a new study for a patient, generate a partial clinical information lattice (PCIL) representative of the new medical study, receive metadata describing a dataset related to a prior study for the patient, generate a complete clinical information lattice (CIL) representative of the dataset, calculate an affinity value for the prior study based on a fit function comparing the PCIL and the CIL, the affinity value indicating a probability of relevancy of the prior study to the new study, identify whether or not the dataset should be prefetched from lower tier memory, and transmit, to the first device, an indication of at least one dataset to be prefetched from lower tier memory.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of a system for providing clinically adaptive prefetching, according to an example embodiment;

FIG. 2 is a block diagram of a clinical prefetch apparatus, according to an example embodiment;

FIG. 3 is a flowchart illustrating operations for providing clinically adaptive prefetching, according to an example embodiment; and

FIG. 4 is a flowchart illustrating operations for initializing and training an affinity fit function, according to an example embodiment.

### DETAILED DESCRIPTION

Some embodiments will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As described above, current prefetching methodologies for prefetching of prior study medical images are reliant on hardcoded prefetch rules. For example, a clinical system may be queued to prefetch data associated with prior studies in preparation for a new study. Preconfigured prefetch rules may define which prior studies should be considered clinically relevant. Such prefetch rules may be dependent on parameters defined by structured data such as predefined categories (e.g., procedure type, patient visit reason, and/or anatomic system), and/or quantitative measurements, (e.g., the age of a patient during a prior study, and/or a number of days before the new study that the prior study was conducted). The prefetch rules are therefore static in nature and require human interaction to initially configure, and subsequently update.

A clinical system using adaptive prefetching may provide improvements over known prefetching systems, as described in further detail herein. A clinically adaptive prefetch system may be initially configured with an exemplar set of commonly accepted new study to relevant prior study relationships. That is, having identified a new study, as well as known prior studies (e.g., verified by a physician, or other qualified practitioner), an affinity fit function may be used to evaluate relationships between the new and prior studies. A clinically adaptive prefetch system may utilize natural language processing to consider unstructured data (e.g., physician written diagnoses, findings and/or recommendations), expanding the amount of metadata analyzed during the analysis of prior studies, when compared to prefetch rules that rely solely on structured parameters.

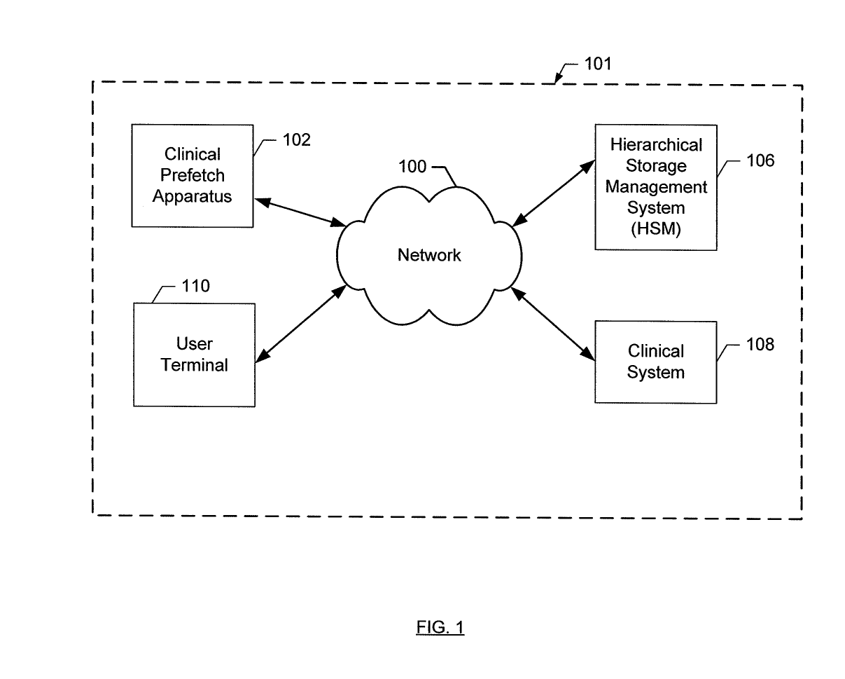

Additionally or alternatively, a clinically adaptive prefetch system may adapt its affinity fit function for a particular clinic and/or practitioner, as it is used, therefore training the fit function based on specific practices and/or evolving medical methodologies. For example, if a new medical scanning device is introduced, physicians may at first manually retrieve associated data. The affinity fit function may therefore be trained, as described in further detail herein, and ultimately the relevant prior studies and associated data may be automatically targeted for prefetch. Without the clinically adaptive prefetch system, in many instances, a physician would have to work with a systems administrator to add and configure a new rule regarding the new medical imaging device (and/or to make updates to existing rules). Various configurations and operations of a clinical prefetch system are described in further detail with respect to FIGS. 1-4 below.

FIG. 1 is a block diagram of a system for providing clinically adaptive prefetching, according to an example embodiment. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing clinically adaptive prefetching, numerous other configurations may also be used to implement embodiments of the present invention.

The system 101 may include a clinical prefetch apparatus 102 that may be configured to provide clinically adaptive prefetching, as introduced above and described in further detail hereinafter. The clinical prefetch apparatus 102 may communicate with HSM 106, clinical system 108, and/or a user terminal 110, among others.

The HSM 106 may be any system, server, apparatus, database, and/or the like such as a medical imaging archiving system configured to store large amounts of data relating to prior medical studies. As such, the HSM 106 may comprise a multi-tiered storage, on which a majority of the data is stored on a relatively inexpensive lower tier memory (or storage), and a smaller, more expensive upper tier is utilized for storing a limited amount of data. In some embodiments, the HSM 106 may be implemented as a network of databases and/or storage mediums, whereby the lowest level and/or least expensive tier is implemented remotely from a higher level, more efficient tier. The clinical prefetch apparatus 102 may therefore communicate with the HSM 106 to indicate which data may be requested in the near future and should be prefetched from a lower tier of memory or storage to a higher tier. A lower tier memory may therefore be considered any memory or storage medium implemented on a multi-tiered memory or storage medium (or distributed network of memory or storage mediums), in which at least one higher tier of memory or storage is available, the higher tier providing a quicker and/or more efficient access time to retrieve data.

The clinical system 108 may be any system, server, server cluster, apparatus, database and/or the like configured by use at a clinic (e.g., a provider of medical care), to provide and/or collect data regarding patients, such as during, prior to, or following a new study (e.g., a patient visit). The clinical system 108 may comprise scheduling information for upcoming appointments, and/or an interface for use in accessing and/or collecting patient data. As such, the clinical system 108 may interface with various medical imaging devices, analysis tools, as well as HSM 106, for accessing prior study data, and storing newly captured patient data. The clinical prefetch apparatus 102 may therefore communicate with clinical system 108 to discover upcoming appointments and/or studies for which prior study data may be requested.

Continuing with FIG. 1, system 101 may additionally and optionally comprise any number of user terminals 110, which may, for example, be embodied as a laptop computer, tablet computer, mobile phone, desktop computer, workstation, or other like computing device. A user terminal 110 may be remote from the clinical prefetch apparatus 102, HSM 106, and/or clinical system 108, in which case the user terminal 110 may communicate with any of the respective apparatuses via network 100. Additionally or alternatively, the user terminal 110 may be implemented on clinical prefetch apparatus 102.

The clinical prefetch apparatus 102 may communicate with any of the HSM 106, clinical system 108, and/or user terminal 110 via any of a variety of methods dependent upon the configuration of the system 101. For example, in embodiments in which a clinical prefetch apparatus 102 is disposed remotely from any of the apparatuses, information such as the use of prior study data, and/or data regarding upcoming new studies may be transmitted, via a network 100, by a variety of connections. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet. As another example, a clinical prefetch apparatus 102 may be directly coupled to any of the HSM 106, clinical system 108, and/or user terminal 110.

In some example embodiments, clinical prefetch apparatus 102 may be embodied as or comprise one or more computing devices, such as, by way of non-limiting example, a server, configured to access network 100. In some example embodiments, clinical prefetch apparatus 102 may be implemented as a distributed system or a cloud based entity that may be implemented within network 100. In this regard, clinical prefetch apparatus 102 may comprise one or more servers, a server cluster, one or more network nodes, a cloud computing infrastructure, some combination thereof, or the like.

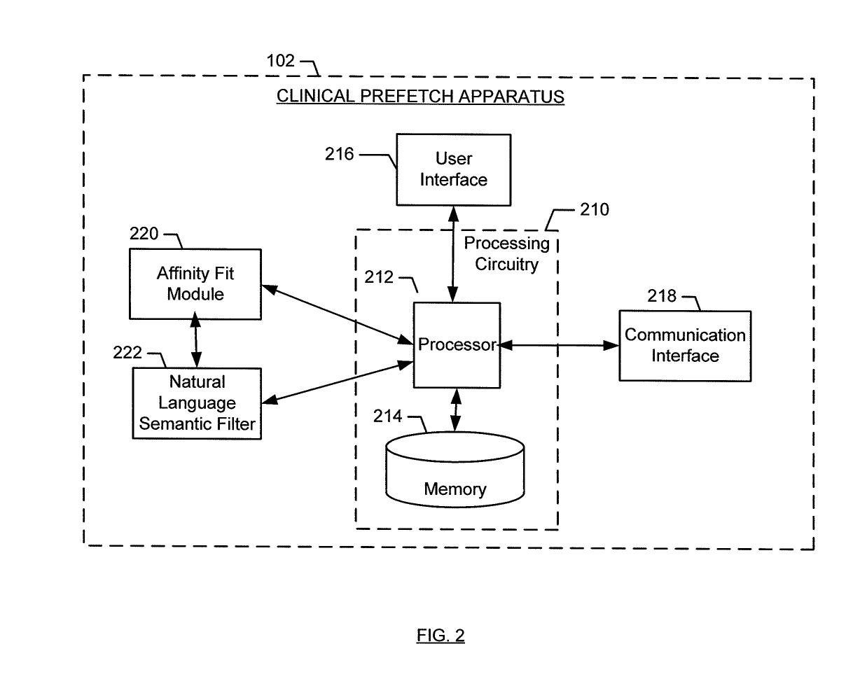

An example embodiment of a clinical prefetch apparatus 102 is illustrated in FIG. 2. It should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

A clinical prefetch apparatus 102 may include processing circuitry 210, which may be configured to perform actions in accordance with one or more example embodiments disclosed herein. In this regard, the processing circuitry 210 may be configured to perform and/or control performance of one or more functionalities of the clinical prefetch apparatus 102 in accordance with various example embodiments. The processing circuitry 210 may be configured to perform data processing, application execution, and/or other processing and management services according to one or more example embodiments. In some embodiments, the clinical prefetch apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216 and/or a communication interface 218. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of clinical prefetch apparatus 102 as described herein. The plurality of processors may be embodied on a single computing device or distributed across a plurality of computing devices collectively configured to function as the clinical prefetch apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the clinical prefetch apparatus 102. The memory 214 may be configured to store information, data, applications, instructions and/or the like for enabling the clinical prefetch apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, and/or communication interface 218, for passing information among components of clinical prefetch apparatus 102.

In some example embodiments, the processor 212 (or the processing circuitry 210) may be embodied as, include, or otherwise control an affinity fit module 220. As such, the affinity fit module 220 may be embodied as various means, such as circuitry, hardware, a computer program product comprising computer readable program instructions stored on a computer readable medium (for example, the memory 214) and executed by a processing device (for example, the processor 212), or some combination thereof. Affinity fit module 220 may be capable of communication with one or more of the processor 212, memory 214, user interface 216, communication interface 218, and natural language semantic filter 222 to access, receive, and/or send data as may be needed to perform one or more of the functionalities of the affinity fit module 220, such as analyzing prior study data for prefetch, as described herein. In some example embodiments, affinity fit module 220 may be implemented as a web service. It will be appreciated that implementing affinity fit module 220 as a web service is cited as a non-limiting example, and should not be construed to narrow the scope or spirit of the disclosure in any way.

In some example embodiments, the processor 212 (or the processing circuitry 210) may be embodied as, include, or otherwise control a natural language semantic filter 222. As such, the natural language semantic filter 222 may be embodied as various means, such as circuitry, hardware, a computer program product comprising computer readable program instructions stored on a computer readable medium (for example, the memory 214) and executed by a processing device (for example, the processor 212), or some combination thereof. Natural language semantic filter 222 may be capable of communication with one or more of the processor 212, memory 214, user interface 216, communication interface 218, and affinity fit module 220 to access, receive, and/or send data as may be needed to perform one or more of the functionalities of the natural language semantic filter 222, such as analyzing unstructured data associated with a prior study, as described herein. In some example embodiments, natural language semantic filter 222 may be implemented as a web service. It will be appreciated that implementing natural language semantic filter 222 as a web service is cited as a non-limiting example, and should not be construed to narrow the scope or spirit of the disclosure in any way.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of clinically adaptive prefetch operations and/or the like. In some example embodiments in which the clinical prefetch apparatus 102 is embodied as a server, cloud computing system, or the like, aspects of user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate clinically adaptive prefetching in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable clinical prefetch apparatus 102 to communicate with various systems over network 100. Accordingly, the communication interface 218 may, for example, include supporting hardware and/or software for enabling communications via cable, digital subscriber line (DSL), universal serial bus (USB), Ethernet, or other methods.

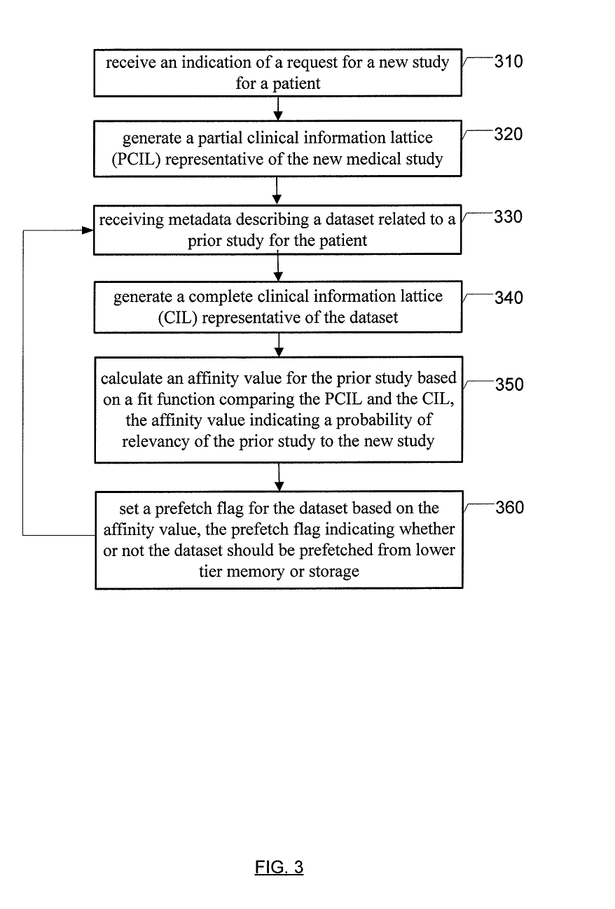

FIG. 3 is a flowchart illustrating operations for providing clinically adaptive prefetching. As shown by operation 310, the clinical prefetch apparatus 102 may be configured, such as with communication interface 218, to receive an indication of a request for a new study for a patient. As such, the clinical system 108 may provide indication of the new study to the clinical prefetch apparatus 102. The indication may be generated based on a scheduling application, for example, and may indicate a subject patient, along with other available patient data related to the new study, such as a patient visit reason, among others.

As shown by operation 320, the clinical prefetch apparatus 102 may be configured, such as with affinity fit module 220, processor 212, and/or the like, to generate a partial clinical information lattice (PCIL) representative of the new medical study. The clinical information lattice may be considered partial because the study has not yet actually been performed, and is absent a diagnostic report, any scan information that may be subsequently captured, and/or the like. The PCIL may be considered a data structure for storing information regarding the new study in a format conducive to rapid automated pattern matching. PCIL will represent in abstract format textual information (e.g., unstructured data) regarding patient history indications for scan, technologist and/or nursing notes, medical alerts, pregnancy status, patient class, current patient location, and/or the like. Additionally a PCIL representative of the new study may additionally comprise structured data such as a procedure type, body region, device modality, requesting service, lab results and quantitative measurements, among others. The PCIL may be temporality stored to memory 214, for example.

Continuing to operation 330, the clinical prefetch apparatus 102 may include means, such as the communication interface 218, for receiving metadata describing a dataset related to a prior study for the patient (e.g., the subject patient of the new study). As such, the clinical prefetch apparatus 102 may receive metadata from the HSM 106. As described above, the HSM 106 may store images, scans, and/or the like of prior medical studies. Metadata, including unstructured data (e.g., diagnostic report, recommendations) and/or structured data (procedure type, body region, device modality, etc.), may be associated with the images in the HSM 106, and therefore transmitted to the clinical fetch apparatus 102 for subsequent processing, as described below.

As shown by operation 340, the clinical prefetch apparatus 102 may include means, such as the affinity fit module 220, natural language semantic filter 222, and/or processor 212, for generating a complete clinical information lattice (CIL) representative of the prior study dataset. As such, the metadata received with respect to operation 330, may be processed and formatted as a CIL, which may be considered a data structure for storing information regarding the prior study. The CIL may comprise similar information to that of a PCIL, but may additionally comprise a diagnostic report and/or location of a scan, among other information that is known only after an exam has been performed. The CIL may therefore extend data elements of a PCIL to include any of a diagnostic report, location of study, make of modality device, model of modality device, lab results and/or quantitative measurements. It will be appreciated that the generating of a CIL (and/or retrieval of the metadata associated with a prior study) may be performed in advance, and stored on HSM 106 and/or clinical prefetch apparatus 102 for subsequent use and/or retrieval. Additionally or alternatively, a CIL may be generated as needed, when the clinical prefetch apparatus 102 receives indication of a new study.

Continuing to operation 350, the clinical prefetch apparatus 102 may include means, such as the affinity fit module 220, for calculating an affinity value for the prior study based on a fit function comparing the PCIL and the CIL, the affinity value indicating a probability of relevancy of the prior study to the new study. The affinity fit module 220, may therefore apply the PCIL and CIL to a fit function, which may analyze structured and/or unstructured data to determine the relevancy of the CIL to the PCIL. As such, the affinity fit module 220 may utilize a natural language semantic filter 222, for example, to process the unstructured data and to extract meaning and/or semantic relationships that can be interpreted by the affinity fit module 220. The natural language semantic filter 222 may, in some embodiments, utilize a clinical synonym dictionary 222 to identify unstructured text in the CIL that should be identified as relevant to the PCIL, such as by normalizing terminology. The affinity fit module may rely on statistical pattern matching to calculate an affinity value for the prior study.

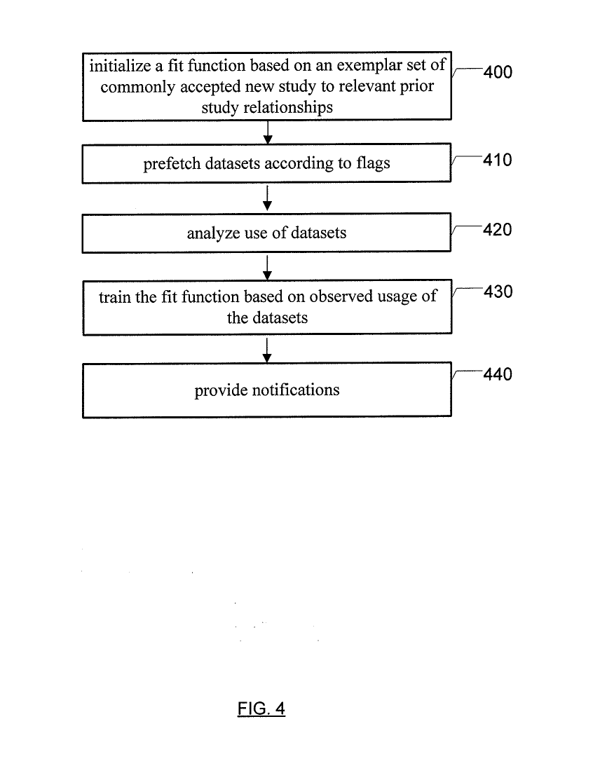

In some embodiments, the CIL and PCIL may represent the clinical information of their respective prior and new studies as higher-geometry shapes in semantic space. The affinity fit module 220 may compute a distance value indicative of how much two shapes “resemble” one another. In some embodiments, the calculation may be based on similar classifications performed in the past, such as described in further detail with respect to FIG. 4.

At operation 360, the clinical prefetch apparatus 102 may be configured, with the affinity fit module 220, and/or processor 212 for example, to set a prefetch flag for the dataset based on the affinity value, the prefetch flag indicating whether or not the dataset should be prefetched from lower tier memory or storage. As such, the affinity value calculated with respect to operation 350 may be considered to determine whether or not the dataset is likely needed by a physician, other practitioner, or the like, and whether it should be retrieved from a lower tier memory or storage medium for storage to and quicker access from a higher tier of memory. In some embodiments, setting a prefetch flag may comprise comparing the particular affinity value to a threshold affinity value, and indicating that those datasets having an affinity value over the threshold affinity value should be flagged for prefetch. In some embodiments, following calculation of affinity values for a plurality of datasets, a certain number of datasets having the highest affinity values may be flagged for prefetch. In some embodiments, the prefetch flag may be a binary flag associated with the dataset. In some embodiments, a list of identifiers associated with the datasets may be tracked so that the correct datasets may be prefetched.

As shown by the connection from operation 360 to 330, the operations 330-360 may be repeated any number of times, for each prior study available in the HSM 106. The creation of a CIL, and calculation of an affinity value for each prior study may ensure that any data that could be potentially requested by a practitioner may be analyzed and/or flagged for prefetch.

FIG. 4 is a flowchart illustrating operations for initializing and training an affinity fit function, according to example embodiments. At operation 400, the clinical prefetch apparatus 102 may be configured to, such as by affinity fit module 220, initialize a fit function based on an exemplar set of commonly accepted new study to relevant prior study relationships. More specifically, the affinity fit module 220 (or processor 212, and/or the like), may analyze a sample study and generate a PCIL representative of the sample study, as if the sample study were a new study being analyzed such as with respect to operation 320 above. Source text information (e.g., unstructured data) for the PCIL of the sample study may include patient history, indications for scan, medical alerts, pregnancy status, patient class, and/or the like. Additional structured data to be incorporated into the sample study PCIL may include a procedure type, body region, device modality, and requesting service, for example.

Having generated a PCIL representative of a sample study, the affinity fit module 220 may then consider a sample set of prior studies, associated with the subject patient of the sample study. Corresponding CILs may be generated to represent the prior studies. The sample set of prior studies may be manually checked by a physician, practitioner, or the like to identify which datasets are needed for comparison during the new study. In some embodiments, the reviewer may even manually assign affinity values, indicating which prior studies have high relevancy to the new study, and which prior studies have low relevancy to the new study. As such, the exemplar PCIL representing the new study, CILs representing the associated prior studies and their associated affinity values may be provided to the affinity fit module 220 to initialize the fit function. As such, similarities between a PCIL and a CIL having a relatively high affinity value may be identified. Similar patterns in subsequent analyses of new to prior studies, such as those performed with respect to operation 350, may indicate a high affinity value.

At operation 410, in some embodiments, the clinical prefetch apparatus 102 may communicate to the HSM 106 to prefetch datasets according to the prefetch flags. As such, the HSM 106 may prefetch the requested datasets from a lower tier storage medium to a higher tier. In some embodiments, the clinical prefetch apparatus 102 may not necessarily cause the prefetch to occur, but may provide the prefetch flags to another system configured to control the prefetching of data.

At operation 420, the clinical prefetch apparatus 102 may analyze the use of datasets during the new study. The clinical system 108 may access datasets flagged for prefetch, allowing an efficient retrieval from a faster storage medium (e.g., a positive identification). In some embodiments, the clinical system 108 may request datasets not flagged for prefetch (e.g., a false negative). Additionally or alternatively, the clinical system 108 may not request a dataset of a prior study that was indeed flagged for prefetch (e.g., a false positive). Regardless of the scenarios the clinical prefetch apparatus 102 may communicate with the clinical system 108 during, or subsequent to a new study, to analyze the use of the datasets and identify false negatives and false positives.

As such, at operation 430, the clinical prefetch apparatus 102 may train the fit function based on the actual aggregate end use behavior (e.g., the use of the datasets). For example, the affinity fit module 220 may adjust the fit function to consider any false negatives and false positives. As such, patterns identified between a PCIL and a CIL of a false negative may be added to the fit function so that subsequent analyses may identify a similar pattern between a PCIL and CIL as a positive match. Similarly, patterns identified between a PCIL and CIL of a false positive may be removed from the fit function so that subsequent analyses will no longer identify an unneeded prior study. In some embodiments, positive identification may be used as reinforcement to further strengthen the fit function. As such, the operations of clinical prefetch apparatus 102 are clinically adaptive. That is, the fit function may be trained over time and may thus obtain a higher level of accuracy in prefetching datasets for a particular clinic, based on the clinic's usage of such datasets during new studies. As further examples, (a) a clinic having recently introduced more advanced, higher resolution devices for body scans may find reduced value in referencing images from prior scans performed on earlier models dating from prior to the upgrade, or (b) a clinic that has recently expanded its staff training in interpretation of images in a particular imaging modality will find that images of that modality are increasingly referred to directly as useful prior study references. The clinical prefetch apparatus 102, such as by configuration of the affinity fit module 220, may be trained to account for these differences, for each clinic, respectively.

In some embodiments, at operation 440, the clinical prefetch apparatus 102 may provide notifications to the clinical system 108, such as by communication interface 218. In embodiments in which a threshold affinity value is used, the clinical prefetch apparatus 102 may detect that too low of a threshold affinity value is resulting in a large number of datasets being flagged for prefetch, potentially impacting the performance of the clinical system 108, clinical prefetch apparatus 102, and/or HSM 106. Similarly, too high of a threshold affinity value may result in an increased number of false negatives and/or an inefficient use of the tiered architecture of the HSM 106. Additionally or alternatively, the clinical prefetch apparatus 102 may consider memory usage, allocation and/or capacities of respective tiers of the HSM 106. In some embodiments, a quantity of datasets identified for prefetch may be considered, such as a percentage of prior studies flagged for prefetch. For example, an affinity fit module 220 found to flag 100% of prior studies for prefetch may be detected as needing further training and/or manual configuration. In some embodiments, the clinical prefetch apparatus 102 may recommend expansion of the top tier memory or storage of the HSM 106. Sending notifications with any of the above described information may therefore alert a user of the clinical system 108 to adjust the threshold affinity value of the prefetch apparatus 102. In some embodiments, the clinical prefetch apparatus 102 may adjust the threshold affinity value automatically.

The functionality of a clinical prefetch apparatus 102 described with respect to FIGS. 3 and 4 may remove or otherwise reduce the need for a human systems administrator to manage a limited set of prefetch rules to achieve maximal HSM and end user efficiency, such as on the clinical system 108. The clinical prefetch apparatus 102 may continually self-tune, automatically adapting to a changes in the specific institutional environment based on actual current use of comparison images in a given patient's clinical circumstance. The clinical prefetch apparatus 102 may also automatically alert the institutions when the only means to achieve a more optimal prefetch result is the expansion of the top tier capacity of the HSM, which is otherwise difficult to determine, since an otherwise manual configuration may depend on a suboptimal prefetch rule configurations.

FIGS. 3 and 4 illustrate flowcharts of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a clinical prefetch apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a clinical prefetch apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

That which is claimed:

1. A method comprising:
receiving an indication of a request for a new study for a patient;
generating, with a processor, a partial clinical information lattice (PCIL) representative of the new medical study;
receiving metadata describing a dataset related to a prior study for the patient;
generating a complete clinical information lattice (CIL) representative of the dataset;
calculating an affinity value for the prior study based on a fit function comparing the PCIL and the CIL, the affinity value indicating a probability of relevancy of the prior study to the new study; and
identifying whether or not the dataset should be prefetched from lower tier memory.

2. The method of claim 1, wherein the PCIL comprises at least one of patient history, scan request, medical alert, pregnancy status, patient class, procedure type, body region, device modality, technologist notes, nursing notes, current patient location or requesting service.

3. A method of claim 1, wherein the CIL extends data elements of a PCIL to include at least one of a diagnostic report, location of study, make of modality device, model of modality device, lab results or quantitative measurements.

4. The method of claim 1, wherein at least one of the PCIL or CIL comprises at least unstructured text, and the fit function utilizes natural language processing to normalize terminology and analyze semantic relationships.

5. The method of claim 1, wherein identifying whether or not the dataset should be prefetched from lower tier memory is based on a comparison of the affinity value to a threshold affinity value.

6. The method of claim 5, further comprising:
analyzing a quantity of datasets identified for prefetch and a memory allocation; and
adjusting the threshold affinity value based on the analysis.

7. The method of claim 1, further comprising:
utilizing actual aggregate end user behavior to identify a false negative dataset, wherein the false negative dataset is a dataset not identified for prefetch, but is requested for retrieval; and
training the fit function based on the false negative and an associated CIL.

8. The method of claim 1, further comprising:
utilizing actual aggregate end user behavior to identify a false positive dataset, wherein the false positive dataset is a dataset erroneously identified for prefetch that is not utilized in the new study; and
training the fit function based on the false positive dataset and an associated CIL.

9. The method of claim 1, further comprising:
generating a notification indicating optimization of the fit function is limited by a capacity of a high level storage medium.

10. The method of claim 1, further comprising:
initializing the fit function based on an exemplar set of commonly accepted new study to relevant prior study relationships.

11. An apparatus comprising at least one processor and at least one memory including computer program code, the at least one memory and the computer program code configured to, with the processor, cause the device to at least:
receive an indication of a request for a new study for a patient;
generate a partial clinical information lattice (PCIL) representative of the new medical study;
receive metadata describing a dataset related to a prior study for the patient;
generate a complete clinical information lattice (CIL) representative of the dataset;
calculate an affinity value for the prior study based on a fit function comparing the PCIL and the CIL, the affinity value indicating a probability of relevancy of the prior study to the new study; and
identify whether or not the dataset should be prefetched from lower tier memory.

12. The apparatus according to claim 11, wherein the PCIL comprises at least one of patient history, scan request, medical alert, pregnancy status, patient class, procedure type, body region, device modality, technologist notes, nursing notes, current patient location or requesting service.

13. The apparatus according to claim 11, wherein the CIL extends data elements of a PCIL to include at least one of a diagnostic report, location of study, make of modality device, model of modality device, lab results or quantitative measurements.

14. The apparatus according to claim 11, wherein at least one of the PCIL or CIL comprises at least unstructured text, and the fit function utilizes natural language processing to normalize terminology and analyze semantic relationships.

15. The apparatus according to claim 11, wherein identifying whether or not the dataset should be prefetched from lower tier memory is based on a comparison of the affinity value to a threshold affinity value.

16. The apparatus according to claim 15, wherein the at least one memory and the computer program code are further configured to, with the processor, cause the device to at least:
analyze a quantity of datasets identified for prefetch and a memory allocation; and
adjust the threshold affinity value based on the analysis.

17. An apparatus according to claim 11, wherein the at least one memory and the computer program code are further configured to, with the processor, cause the device to at least:
utilize actual aggregate end user behavior to identify a false negative dataset, wherein the false negative dataset is a dataset not identified for prefetch, but is requested for retrieval; and
train the fit function based on the false negative and an associated CIL.

18. An apparatus according to claim 11, wherein the at least one memory and the computer program code are further configured to, with the processor, cause the device to at least:
utilize actual aggregate end user behavior to identify a false positive dataset, wherein the false positive dataset is a dataset erroneously identified for prefetch that is not utilized in the new study; and
train the fit function based on the false positive dataset and an associated CIL.

19. An apparatus according to claim 11, wherein the at least one memory and the computer program code are further configured to, with the processor, cause the device to at least:
generate a notification indicating optimization of the fit function is limited by a capacity of a high level storage medium.

20. An apparatus according to claim 11, wherein the at least one memory and the computer program code are further configured to, with the processor, cause the device to at least:
initialize the fit function based on an exemplar set of commonly accepted new study to relevant prior study relationships.

21. A computer program product comprising at least one non-transitory computer-readable storage medium having computer-executable program code instructions stored therein, the computer-executable program code instructions comprising program code instructions to:
authenticate a user affiliated with a clinic;
receive clinical content associated with the clinic, provided by the user;
store the clinical content in association with the clinic such that the clinical content is retrievable based on an indication of the clinic;
receive an indication of a request to view content associated with the clinic; and
cause display of the clinical content in response to the indication of the request.

22. The computer program product of claim 21, wherein the PCIL comprises at least one of patient history, scan request, medical alert, pregnancy status, patient class, procedure type, body region, device modality, technologist notes, nursing notes, current patient location or requesting service.

23. The computer program product of claim 21, wherein the CIL extends data elements of a PCIL to include at least one of a diagnostic report, location of study, make of modality device, model of modality device, lab results or quantitative measurements.

24. The computer program product of claim 21, wherein at least one of the PCIL or CIL comprises at least unstructured text, and the fit function utilizes natural language processing to normalize terminology and analyze semantic relationships.

25. The computer program product of claim 21, wherein identifying whether or not the dataset should be prefetched from lower tier memory is based on a comparison of the affinity value to a threshold affinity value.

26. The computer program product of claim 25, wherein the computer-executable program code instructions further comprise program code instructions to:
analyze a quantity of datasets identified for prefetch and a memory allocation; and
adjust the threshold affinity value based on the analysis.

27. The computer program product of claim 21, wherein the computer-executable program code instructions further comprise program code instructions to:
utilize actual aggregate end user behavior to identify a false negative dataset, wherein the false negative dataset is a dataset not identified for prefetch, but is requested for retrieval; and
train the fit function based on the false negative and an associated CIL.

28. The computer program product of claim 21, wherein the computer-executable program code instructions further comprise program code instructions to:
utilize actual aggregate end user behavior to identify a false positive dataset, wherein the false positive dataset is a dataset erroneously identified for prefetch that is not utilized in the new study; and
train the fit function based on the false positive dataset and an associated CIL.

29. The computer program product of claim 21, wherein the computer-executable program code instructions further comprise program code instructions to:
generate a notification indicating optimization of the fit function is limited by a capacity of a high level storage medium.

30. The computer program product of claim 21, wherein the computer-executable program code instructions further comprise program code instructions to:
initialize the fit function based on an exemplar set of commonly accepted new study to relevant prior study relationships.

31. A system comprising:
(a) a first device configured to:
provide an indication of a request for a new study for a patient;
transmit the indication to a second device; and
receive, from the second device, an indication of at least one dataset to be prefetched from lower tier memory;
(b) a second device configured to:
receive, from the first device, the indication of a request for a new study for a patient;
generate a partial clinical information lattice (PCIL) representative of the new medical study;
receive metadata describing a dataset related to a prior study for the patient;
generate a complete clinical information lattice (CIL) representative of the dataset;
calculate an affinity value for the prior study based on a fit function comparing the PCIL and the CIL, the affinity value indicating a probability of relevancy of the prior study to the new study;
identify whether or not the dataset should be prefetched from lower tier memory; and
transmit, to the first device, an indication of at least one dataset to be prefetched from lower tier memory.
